(19) United States
(12) Patent Application Publication
(10) Pub. No.: US 2025/0386194 A1
(43) Pub. Date: Dec. 18, 2025

(54) SECURITY IN 5G FRONTHAUL NETWORKS

(71) Applicant: Microsoft Technology Licensing, LLC, Redmond, WA (US)

(72) Inventors: Xenofon FOUKAS, Cambridge (GB); Bozidar RADUNOVIC, Cambridge (GB); Daehyeok KIM, Austin, TX (US); Jiarong XING, Houston, TX (US); Sophia YOO, Schwenksville, PA (US)

(21) Appl. No.: 18/743,792

(22) Filed: Jun. 14, 2024

(51) Int. Cl. H04W 12/122; H04W 12/106; H04W 12/61

(52) U.S. Cl. CPC H04W 12/122; H04W 12/106; H04W 12/61

(57) ABSTRACT

Example implementations include a method, apparatus, and computer-readable medium configured for improving security in a 5G fronthaul network. A device monitors characteristics of a plurality of packets transmitted over an interface between a radio unit and a distributed unit including microsecond level timing information of the plurality of packets transmitted over the interface including microsecond level timing information of the plurality of packets transmitted over the interface. A device detects an anomaly based at least in part on a deviation in the characteristics among the plurality of packets transmitted over the interface. A device identifies the interface between the radio unit and the distributed unit as potentially compromised based at least in part on the anomaly. In some implementations, the device may control one or both of the radio unit or the distributed unit to perform a mitigation action in response to identifying the interface as potentially compromised.

### TECHNICAL FIELD

The present disclosure relates to communications networks and, in particular, to security in 5G fronthaul networks.

### BACKGROUND

A radio access network (RAN) may provide multiple user devices with wireless access to a network. The user devices may wirelessly communicate with a base station, which forwards the communications towards a core network. Conventionally, a base station in the RAN is implemented by dedicated processing hardware (e.g., an embedded system) located close to a radio unit including antennas. The base station may perform lower layer processing including physical (PHY) layer and media access control (MAC) layer processing for one or more cells. There may be costs associated with deploying dedicated processing hardware for each base station in a RAN, particularly for a RAN including small cells with relatively small coverage areas. Additionally, the dedicated processing hardware may be a single point of failure for the cell.

A virtualized radio access network may utilize an edge data center with generic computing resources for performing RAN processing for one or more cells. That is, instead of performing PHY and MAC layer processing locally on dedicated hardware, a virtualized radio access network may forward radio signals from the radio units to the edge data center for processing and similarly forward signals from the edge data center to the radio units for wireless transmission. In one specific example, cloud-computing environments can be used to provide mobile edge computing (MEC) where certain functions of a mobile network can be provided as workloads on nodes in the cloud-computing environment. In MEC, a centralized unit (CU) can be implemented in a back-end node, one or more distributed units (DUs) can be implemented in intermediate nodes, and various remote units (RU), which can provide at least PHY and/or MAC layers of a base station or other RAN node of the mobile network, can be deployed at edge servers. The RUs can communicate with the CU via one or more DUs. In an example, the DUs can provide higher network layer functionality for the RAN, such as radio link control (RLC) or packet data convergence protocol (PDCP) layer functions. The RUs can facilitate access to the CU for various downstream devices, such as user equipment (UE), Internet-of-Things (IoT) devices, etc.

The modern 5G fronthaul, which connects the base stations to radio units in cellular networks, is designed to deliver microsecond-level performance guarantees using Ethernet-based protocols. Unfortunately, due to potential performance overheads, as well as misconceptions about the low risk and impact of possible attacks, integrity protection is not considered a mandatory feature in the 5G fronthaul standards.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to an apparatus including: one or more memories storing computer executable instructions; and one or more processors coupled with the one or more memories and, individually or in combination, configured to: monitor characteristics of a plurality of packets transmitted over an interface between a radio unit and a distributed unit including microsecond level timing information of the plurality of packets transmitted over the interface; detect an anomaly based on a deviation in the microsecond level timing information among the plurality of packets transmitted over the interface; and identify the interface between the radio unit and the distributed unit as potentially compromised based at least in part on the anomaly.

In some aspects, the techniques described herein relate to a method of security in a 5G fronthaul network, including: monitoring characteristics of a plurality of packets transmitted over an interface between a radio unit and a distributed unit including microsecond level timing information of the plurality of packets transmitted over the interface; detecting an anomaly based on a deviation in the microsecond level timing information among the plurality of packets transmitted over the interface; and identifying the interface between the radio unit and the distributed unit as potentially compromised based at least in part on the anomaly.

In some aspects, the techniques described herein relate to a non-transitory computer-readable medium storing computer-executable instructions that when executed by one or more processors of a network node, cause the network node to: monitor characteristics of a plurality of packets transmitted over an interface between a radio unit and a distributed unit including microsecond level timing information of the plurality of packets transmitted over the interface; detect an anomaly based on a deviation in the microsecond level timing information among the plurality of packets transmitted over the interface; and identify the interface between the radio unit and the distributed unit as potentially compromised based at least in part on the anomaly.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example virtualized radio access network (vRAN) that provides connectivity to a user equipment (UE).

FIG. 2 is a diagram of communications on an example interface between a radio unit (RU) and a distributed unit (DU).

FIG. 3 is a diagram of connections and protection in an example 5G fronthaul network.

FIG. 4 is a diagram of an example attack via cell reselection.

FIG. 5 is a diagram of an example attack via handovers.

FIG. 6 is a schematic diagram of an example of an apparatus (e.g., a computing device) for identifying potentially compromised fronthaul interfaces of a communication network (e.g., a 5G network).

FIG. 7 is a flow diagram of an example of a method for providing security in a fronthaul of a communication network.

FIG. 8 illustrates an example of a device including additional optional component details as those shown in FIG. 6.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to security in a fronthaul portion of an open architecture for a communications network such as a 5G radio access network (RAN). Current standards for such networks do not provide integrity protection for an interface between a radio unit and a distributed unit. Although the standards organizations concluded that the threat to this interface is low and the cost of integrity protection too high, several new attacks increase the threat.

The present disclosure provides techniques for security of the fronthaul interface through detection and mitigation of potentially compromised interfaces. A network node monitors characteristics of a plurality of packets transmitted over an interface between a radio unit and a distributed unit including microsecond level timing information of the plurality of packets transmitted over the interface. The network node detects an anomaly based on a deviation in the characteristics among the plurality of packets transmitted over the interface such as an increased variation in the microsecond level timing information. The network node identifies the interface between the radio unit and the distributed unit as potentially compromised based at least in part on the anomaly. In some implementations, the network node controls one or both of the radio unit or the distributed unit to perform a mitigation action in response to identifying the interface as potentially compromised.

Implementations of the present disclosure may realize one or more of the following technical effects. Identifying a compromised interface improves security of the network by identification of potential attacks against network services. Mitigation steps for specific variations of attack improve network functioning by preventing damage from the attacks based on the compromised interface. Selective integrity protection of data over the interface between the radio unit and the distributed unit prevents attacks while meeting radio network timing requirements.

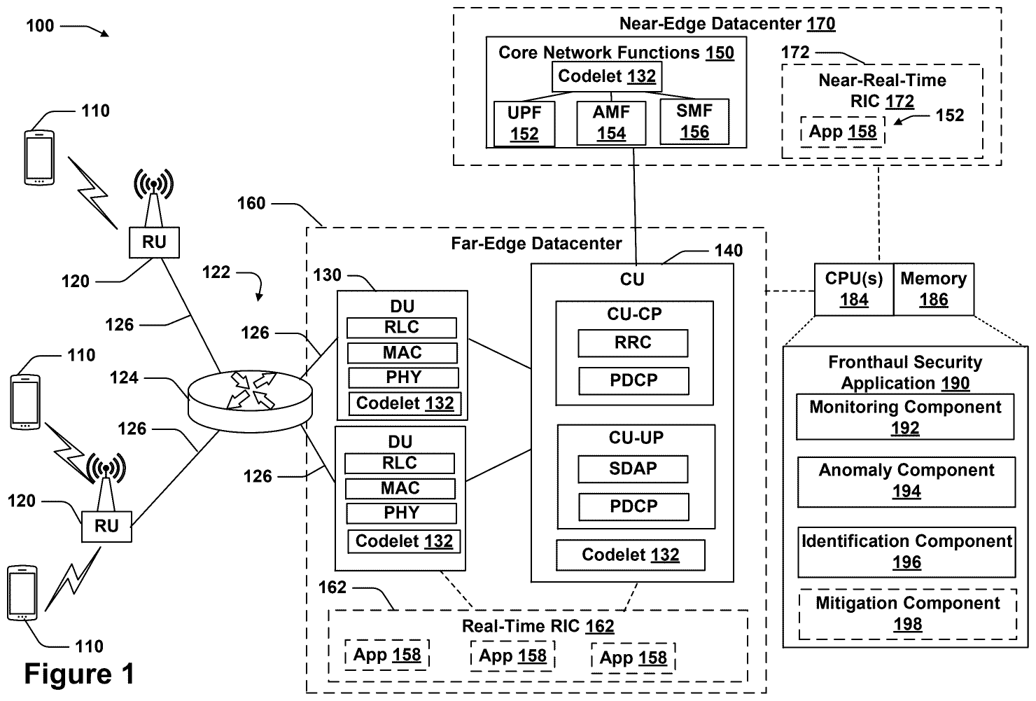

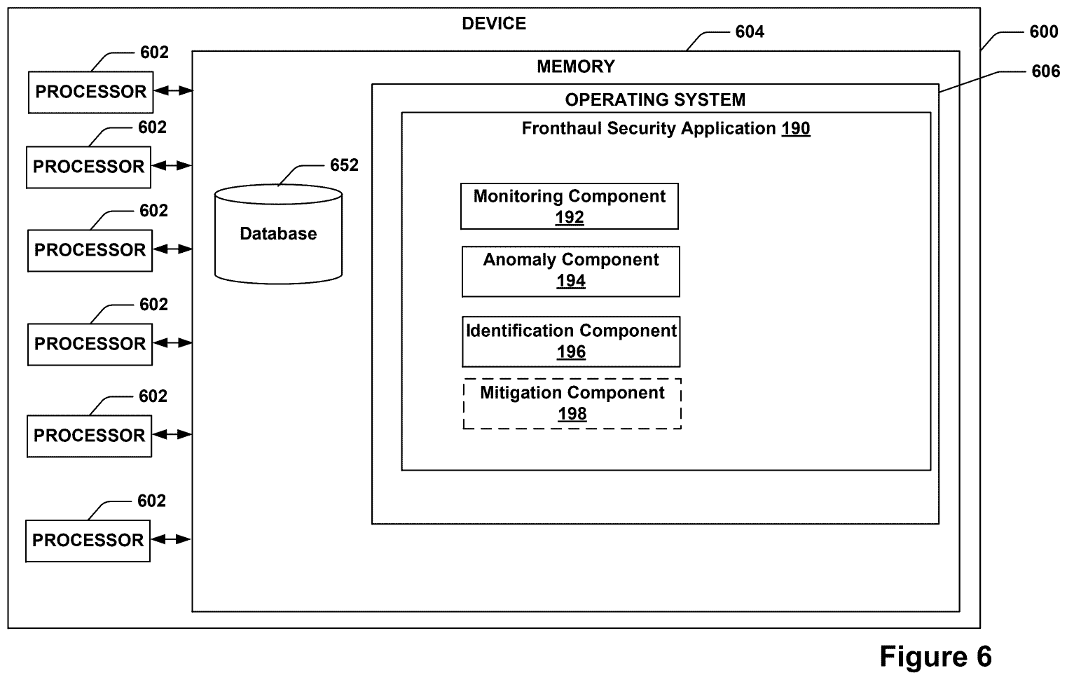

Turning now to FIGS. 1-8, examples are depicted with reference to one or more components and one or more methods that may perform the actions or operations described herein, where components and/or actions/operations in dashed line may be optional. Although the operations described below in FIG. 6 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a diagram of an example virtualized radio access network (vRAN) 100 that provides connectivity to a user equipment (UE) 110. For example, the vRAN 100 may implement a 5G communications network based on the Open RAN (O-RAN) architecture. The O-RAN architecture is a widely accepted reference 5G architecture driven by the O-RAN Alliance and 3rd Generation Partnership Project (3GPP) standards bodies, which provide specifications for interfaces and protocols. O-RAN is globally supported by many major network opera-tors, adopted by the European Telecommunications Standards Institute (ETSI), recognized by hundreds of other operators, vendors, research and academic institutions, and is being deployed in many large-scale networks around the world today. The vRAN 100 may include radio units (RU) 120 that transmit and receive wireless signals with the UE 110. The vRAN 100 may include a virtual distributed unit (DU) 130 that performs processing, for example, at the physical (PHY) layer, media access control (MAC) layer, and radio link control (RLC) layer. The vRAN 100 may include a virtual central unit (CU) 140 that performs processing at higher layers of the wireless protocol stack. The DU 130 may be referred to as a vDU, and the CU 140 may be referred to as a vCU. The vRAN 100 may include core network functions 150 that provide user and session management.

As shown in FIG. 1, the baseband unit (BBU) and colocated remote radio unit (RRU) of traditional RANs (e.g., used in 4G) are disaggregated into a Radio Unit (RU), Distributed Unit (DU), and Centralized Unit (CU) in modern 5G RANs, where one CU can serve multiple DUs. The RAN functions that previously ran on proprietary vendor-specific hardware are now virtualized, running in software on commodity off-the-shelf (COTS) servers, reducing vendor lock-in and enabling more rapid innovation.

The division of functionality between the DU 130 and the CU 140 may depend on a functional split architecture. The CU 140 may be divided into a central unit control plane (CU-CP) and central unit user plane (CU-UP). CU-UP may include the packet data convergence protocol (PDCP) layer and the service data adaptation (SDAP) layer, and the radio resource control (RRC) layer. Different components or layers may have different latency and throughput requirements. For example, the PHY layer may have latency requirements between 125 μs and 1 ms and a throughput requirement greater than 1 Gbps, the MAC and RLC layers may have latency requirements between 125 μs and 1 ms and a throughput requirement greater than 100 Mbps, and the higher layers at the CU may have latency requirements greater than 125 μs and a throughput requirement greater than 100 Mbps.

Higher layer network functions may be referred to as core network functions 150. For example, the core network functions may include one or more Access and Mobility Management Functions (AMFs) 154, a Session Management Function (SMF) 156, and a User Plane Function (UPF) 152. These network functions may provide for management of connectivity of the UE 110. For example, the UPF 152 may provide processing of user traffic to and from the Internet. For instance, a UPF 152 may receive user traffic packets and forward the packets to a server via one or more routers using Internet protocol.

In some implementations, the vRAN 100 includes a RAN intelligent controller (RIC) that performs autonomous configuration and optimization of the vRAN 100. The RIC is implemented at multiple locations as a real-time RIC 162, a near-real-time RIC 172, or a non-real-time RIC. For instance, the real-time RIC 162 is executed at a far-edge datacenter 160 that also executes a vRAN function such as the DU 130 or the CU 140. The near-real-time RIC 172 is executed at a near-edge datacenter 170. The non-real-time RIC may be executed at either the near-edge datacenter 170 or a cloud datacenter. In an aspect, each datacenter is associated with a set of computing resources. For example, the computing resources at the far-edge datacenter 160 are a first set of computing resources and the computing resources at the near-edge datacenter 170 are a second set of computing resources.

Programmability in vRAN functions (e.g., Open RAN components) may be facilitated through codelets 132 and the RIC. A network operator can install applications (Apps 158, e.g., xApps in Open RAN) on top of any of the real-time RIC 162. the near-real-time RIC 172, or a non-real-time RIC (not shown). In an aspect, the network functions of the vRAN 100 such as the DU 130 and the CU 140 may be programmed by installing a codelet 132 to execute at a hook point within the network function. The codelet 132 may be a piece of extended Berkeley packet filter (eBPF) code that is verified for execution within the network function. The codelet 132 may be configured to export operational data of the network function.

Each RIC may collect network data from the network functions using the codelets 132 and may leverage the network data to optimize network performance or report issues on a time-frame based on location. For example, a real-time RIC may operate with latency less than 10 milliseconds (ms); the near-real-time RIC 172 may operates with latency greater than 10 ms to seconds; and the non-real-time RIC may operate with latency greater than 10 seconds. The RICs may obtain the network data from various sources. For example, the data collection and control of the vRAN components may be facilitated through service models that are embedded in the vRAN functions by vendors. The service models may explicitly define the type and frequency of data reporting for each App 158, as well as a list of control policies that the RIC can use to modify the RAN behavior. Such services models may collect significant network events occur at a relatively low rate (100 s of ms to seconds), which is suitable for the near-real-time RIC 172 and the non-real-time RIC. In some implementations, a dynamic service model may define hook points and operational data that can be accessed by a codelet 132 at each hook point.

A key part of the 5G RAN architecture is the fronthaul interface 122, which transports user and control data between the DU 130 and RU 120, to be converted into wireless signals for transmission to user equipment (UEs) 110. Unlike traditional RANs, where fronthaul connectivity is realized using a proprietary link-layer protocol called the Common Public Radio Interface (CPRI), the 5G fronthaul uses Ethernet-based enhanced CPRI (eCPRI), which was designed for performance and to enable emerging technologies, like Massive MIMO. For example, the fronthaul interface 122 may include an Ethernet switch 124 and Ethernet links 126 between the Ethernet switch 124 and the DU 130 and/or the RU 120. In some implementations, the fronthaul interface may include only one or more Ethernet links 126 between a DU 130 and the RU 120.

However, as an Ethernet-based interface, the fronthaul interface 122 is vulnerable to packet manipulation attacks. Adversaries that have gained access to the physical RAN infrastructure can insert themselves between the DU 130 and RU 120, acting as a man-in-the-middle (MITM) adversary. From there, they can manipulate fronthaul packets to cause service degradation or connection disruption (e.g., denial of service to attached UEs 110).

To protect against MITM attacks, integrity protection of fronthaul packets via solutions like MACSec and IPSec would be a natural approach. However, integrity protection of fronthaul traffic is currently optional in the protocol standards, due to concerns of increased processing delay incurred by potential security mechanisms, which could break the stringent performance requirements of the eCPRI protocol. According to the O-RAN Security Work Group, the standardization body responsible for formulating security specifications for fronthaul, lack of integrity protection over fronthaul is acceptable for three perceived reasons:
R1—Low likelihood for MITM attacks over fronthaul.
R2—Costly sophistication required on the part of an adversary to launch attacks.
R3—Low severity of potential attacks.

Contrary to these reasons, the inventors have discovered multiple attacks against a 5G fronthaul that warrant reconsideration of the assumptions for 5G fronthaul. The following observations directly challenge the commonly accepted security stance:
O1—MITM fronthaul attacks are practical and feasible to launch, in a manner that bypasses the port-based network access control of IEEE 802.1X, on which the standards rely for their security stance.
O2—Adversaries do not need to be overly sophisticated to launch meaningful attacks, and can directly manipulate vulnerable fronthaul traffic that is left unsecured by protection mechanisms such as PDCP (Packet Data Convergence Protocol), which only protect certain data and leave other critical fronthaul messages unsecured.
O3—Attacks exploiting the lack of fronthaul integrity can be severe, impacting RAN processes at a higher layer than that of the targeted DU, expanding over vast geographical regions, and affecting mobile users in cells that are not even directly under attack.

Further, this disclosure provides techniques for detecting and mitigating such attacks. In an aspect, the present disclosure provides techniques for evaluating communications on the fronthaul to detect anomalies that indicate the fronthaul has been compromised. The characteristics of a plurality of packets transmitted over an interface between a radio unit and a distributed unit can be monitored for anomalies. For example, each type of attack may produce a distinct anomaly in user data or control signals over the fronthaul. When an anomaly is detected, the particular interface associated with the anomaly can be identified as potentially compromised. Further actions can be taken with respect to the potentially compromised interface to mitigate attacks against more central parts of the network (e.g., the CU 140).

In an aspect, a fronthaul security application 190 provides security for the fronthaul interface 122. The fronthaul security application 190 may be executed as an app 158 in a datacenter such as the far-edge datacenter 160 or the near-edge datacenter 170. For instance, the fronthaul security application 190 may include instructions stored in a memory 186 that are executed by one or more processors such as CPU(s) 184. The memory 186 and the one or more processors 184 may be computing resources at a datacenter such as the far-edge datacenter 160 or the near-edge datacenter 170. The fronthaul security application 190 includes a monitoring component 192, an anomaly component 194, and an identification component 196. The fronthaul security application 190 may optionally include a mitigation component 198. The monitoring component 192 is configured to monitor characteristics of a plurality of packets transmitted over an interface between a radio unit and a distributed unit. The anomaly component 194 is configured to detect an anomaly based on a deviation in the characteristics among the plurality of packets transmitted over the interface. The identification component 196 is configured to identifying the interface between the radio unit and the distributed unit as potentially compromised based at least in part on the anomaly. The mitigation component 198 may be configured to apply a mitigation action to the identified interface based at least in part on the anomaly.

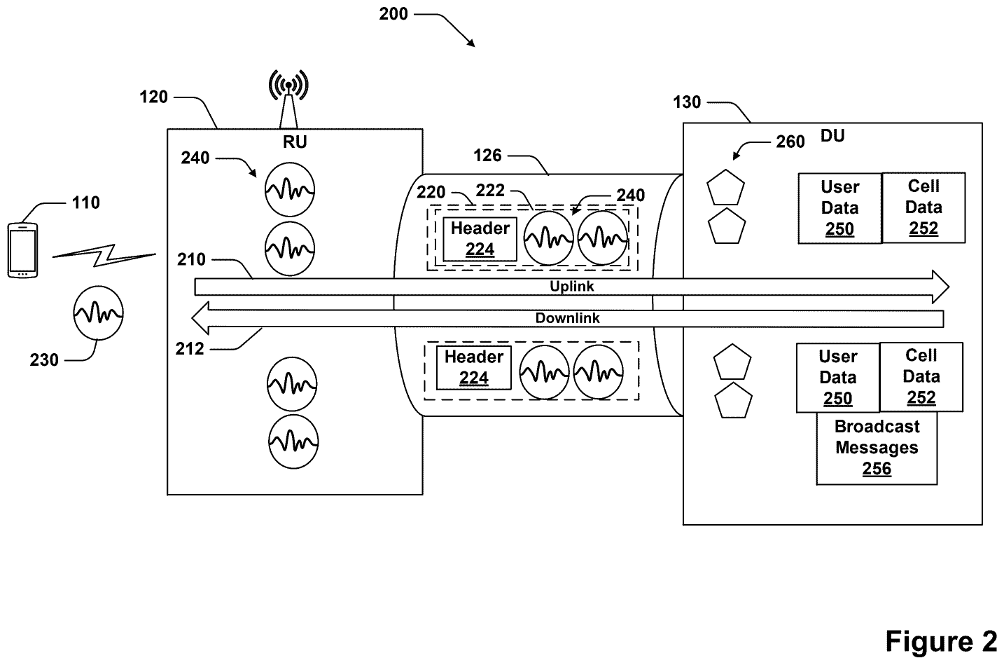

FIG. 2 is a diagram of communications on an example interface 200 between a RU 120 and a DU 130. As shown in FIG. 2, modern fronthaul protocols between RU 120 and DU 130 run over an Ethernet link 126. The use of Ethernet makes the packet structure of the fronthaul highly accessible (i.e., publicly known). In the case of the control and user planes, packets are encapsulated using either eCPRI or IEEE Radio over Ethernet (RoE), with the eCPRI variant having met the most widespread success.

The eCPRI specification has been a cooperative effort amongst the biggest telco vendors and defines the structure of the Ethernet frame carrying the fronthaul data (e.g., types of eCPRI packets). However, certain implementation details (e.g., the exact contents of the payload) are left out of the specification, meaning that eCPRI is not interoperable across vendors. To fill this gap, in recent years, the O-RAN Alliance and ETSI standardization bodies have built on top of eCPRI and have provided a full specification, which enables interoperability between the RUs and the DUs of different RAN vendors. The popularity of eCPRI-based O-RAN is apparent by the adoption that it has seen in the networks of major telco operators. Given the widespread adoption of the eCPRI-based O-RAN fronthaul, examples are provided with respect to this variant for simplicity. However, it should be noted that this disclosure also applies to the more general eCPRI specification. The fronthaul interface 122 enables the communication of the DU 130 and the RU 120 through downlink 210 (DU-to-RU) and uplink 212 (RU-to-DU) transmissions. The O-RAN fronthaul specifies four different communication planes: synchronization plane (S-plane), management plane (M-plane), control plane (C-plane), and user plane (U-plane). This disclosure focuses on the U-plane, which transfers waveforms 230 transmitted to and from the radio in the frequency domain, carrying both user data 250 and cell data 252. While the C-, S-, and M-plane traffic is entirely internal to the fronthaul (remaining between the DU and RU) and is thus invisible to UEs, U-plane traffic carries data to and from the UEs and can have the most immediately obvious impact on UEs.

The U-plane transports baseband signals between the RU and the DU. These signals are transferred in the form of I/Q samples 240 in the frequency domain, which are complex numbers with a real (I) and an imaginary (Q) part. The number of I/Q samples 240 each U-plane packet carries depends on the RU and cell configuration (e.g., cell bandwidth, number of antenna ports, etc.). Each U-plane packet 222 carries a set of I/Q samples 240 that fit into one symbol 260, defined by a specific transmission window (e.g., 35 μs). The transmission of U-plane messages across the fronthaul depends on timing to provide real-time performance guarantees for latency-critical use cases. Thus, all DUs and RUs must transmit messages using a rigid symbol-based schedule. The exact latency tolerance of the fronthaul depends on the supported use cases, but generally, it should not exceed 100 μs for typical deployment scenarios.

Among other fields, each U-plane packet 222 has a source and destination MAC address (that of the DU or the RU) carried in a header part of an Ethernet frame 220. U-plane packets 222 also contain an RU (logical) port ID, as part of their eCPRI header 224, that designates the antenna port that the I/Q samples are being transferred to/from.

Baseband signals transmit data to/from the higher layers of the RAN. This includes user application data and broadcast and control messages transmitted by RUs in the downlink direction from higher layers and requested by UEs on-demand in the uplink direction. Broadcast messages 256 are required for downlink and uplink synchronization and carry real-time control signals that allow UEs to discover the cells and provide UEs with technical instructions on attaching to cells. The loss of these broadcast messages 256 affects the ability of UEs to successfully attach to a cell.

To provide context for the attacks discussed herein, two important control messages transmitted in the downlink direction over fronthaul are described: the Synchronization Signal Block (SSB) and System Information Block 1 (SIB1). These are the first message blocks decoded by the UE during cell search, enabling it to identify the cell, synchronize timing, discover cell uplink and downlink configurations, and determine how to decode future message blocks. For uplink, another important control message is the Physical Random Access Channel (PRACH), which allows the UE 110 to achieve uplink synchronization and align transmission timing with the RU 120.

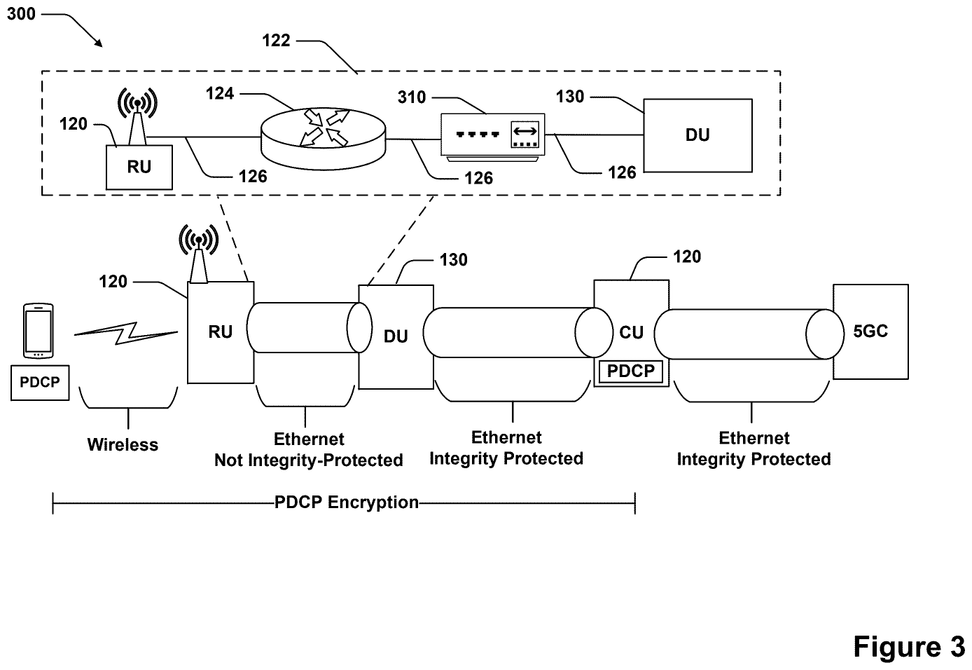

FIG. 3 is a diagram of connections and protection in an example 5G fronthaul network 300. The fronthaul network 300 may include one or more software-based DUs 130 running on commodity servers in an edge site. These DUs 130 are interconnected via physical Ethernet link 126, potentially through an Ethernet switch 124, to one or more commercial RUs 120, which broadcast radio signals to all UEs 110 in their coverage region.

The adversary's goal is to insert herself as an MITM on the link between the DU(s) 130 and RU(s) 120 to stealthily modify fronthaul packets and cause connection degradation or disruption for users. The fronthaul interface 122 is secured using IEEE 802.1X, but adversaries can bypass this protection by obtaining an initial foothold for MITM attacks through on-site access to the 5G edge site, through insider threats motivated by competition or financial gain, or through supply chain vulnerabilities, particularly from untrustworthy vendors. The O-RAN security standards body deemed the likelihood of MITM attacks to be low (R1) because of existing security requirements, namely port-based authentication of RAN equipment with IEEE 802.1X. However, this assumption does not hold in various scenarios, creating vulnerabilities that could be exploited.

On-site 802.1X bypassing. O-RAN requires a device to be authenticated and authorized through IEEE 802.1X before it can connect to the fronthaul network, which prevents illegal access and potential security breaches from rogue devices. However, in the case of wired networks, IEEE 802.1X is vulnerable to interceptors that introduce passive devices in the link with on-site access. This is possible for 5G fronthaul, where server clusters are typically co-located with base stations and spread geographically across the edge. Therefore, obtaining physical access to these fronthaul clusters, akin to accessing outdoor IoT devices, could be easier than accessing traditional centralized cloud data centers. Adversaries with physical access to the 5G edge site can bypass IEEE 802.1X by inserting a rogue server 310 with two network interfaces (e.g., a mini PC) into the fronthaul, as shown in FIG. 3. The rogue server 310 could work as a network bridge that modifies and forwards traffic using the original connections already authenticated by IEEE 802.1X.

Insider threats. In addition to external threats, fronthaul MITM attacks can be enabled by insider threats, which originate from within the targeted organization. This can include current or former employees, contractors, or business associates with inside access to the company infrastructure. A recent survey revealed that insider threats have become more frequent, and more than 50% of organizations experienced such threats at least once in 2023. Insider threats facilitate the ease of launching MITM attacks by installing malicious devices (e.g., rogue server 310) within the fronthaul cluster. This method parallels the previously discussed 802.1X bypass but with the added advantage of legitimate on-site access. Moreover, insiders could even bypass 802.1X remotely by installing malicious software on the DU servers to enable packet interception. Example motivators for employees to engage in such attacks could include financial gains from service competitors or harbored resentment for former organizations.

Supply chain vulnerabilities. With 5G infrastructure being built by multiple global vendors, supply chain security becomes a major concern. A recent government report identified 5G supply chain attacks as a significant threat vector. Using fronthaul hardware and software from untrusted providers (e.g., adversarial countries) provides a foothold for MITM attacks. For instance, an adversary could leave a backdoor on the Ethernet switch 124 hardware to manipulate the fronthaul traffic. Similarly, malicious RU firmware and DU implementations can achieve the same purpose. Notably, such breaches will not result in detection from 802.1X protocol violations, making them particularly stealthy.

Recall that the standards group deemed that because of the existing security requirement for the Packet Data Convergence Protocol (PDCP), which is expected to provide integrity protection of user data at higher layers between the CU and UE, an adversary would need to be sophisticated to bypass this protection and launch attacks (R2). The standards group also deemed that potential attacks on the fronthaul would only have low severity (R3), with the expectation that any impact on the RAN would be minor or unnoticeable and that only one DU/RU pair could be affected. In contrast, the PDCP security mechanism does not safe-guard all fronthaul traffic between the DU and RU, leaving critical messages and traffic generated from layers lower than that of PDCP unsecured and vulnerable to adversaries that are not overly sophisticated. Accordingly, several practical, high-impact attacks over fronthaul can break the existing security assumptions, and can impact many DU/RU pairs.

Incomplete PDCP integrity protection. The PDCP is expected to provide confidentiality and integrity protection for data transmitted between the CU and UE. As shown in FIG. 3, PDCP is an L2 protocol in the 5G protocol stack that operates from the CU 140 to the UE 110. The PDCP layer provides several services, including integrity protection, to ensure that data packets are not tampered with during transmission. The PDCP layer achieves this by generating and validating a Message Authentication Code (MAC-I) for each data packet, ensuring detection of unauthorized modifications to the contents of the data packets.

However, these mechanisms are insufficient to protect the open fronthaul from MITM attacks, even from relatively unsophisticated adversaries. The PDCP security mechanism does not safeguard all fronthaul traffic. First, the MAC-I generation and validation require the senders and receivers to use a negotiated key, which is only attainable after UEs 110 attach to a cell, leaving all pre-attachment messages entirely unprotected. In other words, all traffic associated with the initial UE attachment procedure, particularly all broadcast messages, remains unprotected by PDCP. Second, certain fronthaul traffic originates from layers lower in the 5G protocol stack than PDCP. For example, broadcast messages (e.g., SSB data carrying cell selection information needed for UE attachment) are generated by the MAC layer at the DU 130. This type of traffic falls outside the purview of PDCP, thus remaining unsecured. In addition, the PDCP MAC-I is only verified by the UE 110 (downlink) and CU 140 (uplink), exposing the system to packet modification or injection attacks that target the intermediate RU 120 and DU 130.

This vulnerability enables relatively unsophisticated adversaries to launch two types of high-impact MITM attacks as follows: signaling storm attacks and physical layer attacks. Signaling storm attacks leverage the fact that each CU handles multiple edge sites. These attacks introduce signaling storms at the CU, significantly degrading CU performance through fronthaul routing manipulation and I/Q sample multiplexing. The attack impact extends to vast geographical regions, impacting all DUs and their associated RUs and UEs, even those that are not directly associated with the cells where the attacks are initiated. Physical layer attacks are a variety of traditional attacks, which target breaking the physical layer. Once an adversary has gained the status of MITM, she can easily attack the system by directly viewing and modifying the fronthaul traffic on the fly, using only “simple” packet capture and modification techniques, without additional hardware or sophisticated signal-processing mechanisms. This can leak critical information about the cell, degrade the performance of the cell, or cause denial of service to all UEs within the cell. Example physical layer attacks can achieve similar goals and effects as traditional physical layer attacks (e.g., fake base station attacks, radio link jamming, and signal overshadowing). However, unlike prior work, physical layer attacks against the fronthaul interface 122 do not require a transmitter and can operate on a much larger scale, encompassing all the cells that are under the control of the affected DU.

The following attacks can be implemented in approximately 1000 lines of C++ code based on DPDK for high performance. The attacks capitalize on the lack of integrity protection of both the header and payload of U-plane messages, stealthily modifying fronthaul I/Q samples at line rate without raising an alarm. For traffic that does not need to be modified, the attack includes passive eavesdropping and simple forwarding, i.e., each packet received from the DU 130 is passively forwarded to the RU 120, and vice versa. To launch the different attacks, the following low-level packet manipulation capabilities may be used toward the goal of causing UE misbehavior or service disruption:
C1: Ethernet Header Manipulation—modification of the source and destination MAC addresses of U-plane packets to re-route them to different RUs or to make the DU believe that the packet arrived from a different source RU.
C2: I/Q Sample Multiplexing—Summation of the values of I/Q samples (complex number) carried in the U-plane packets for two cells-equivalent to having both cells transmit and receive signals in overlapping regions, causing interference with each other.
C3: I/Q Sample Scaling—multiplying the values of I/Q samples carried in a U-plane packet by a scaling factor-equivalent to scaling the signal's power (e.g., attenuating) by the square of that factor.
C4: I/Q Sample Replacement-replacing the payload of U-plane packets with a different set of I/Q samples, which could be completely random, actual I/Q sample traces captured and replayed from the same or a different cell, or I/Q samples manipulated through C2 and C3.

I/Q samples carried in U-plane packets are typically compressed using standardized lightweight compression techniques (e.g., Block Floating Point (BFP) and u-law compression). Thus, to perform operations on I/Q samples, the rogue server 310 must first decompress them before modification, and then re-compress them before forwarding. BFP-based (de) compression can be accelerated using Intel Advanced Vector Extensions 512 (AVX-512) instructions to reduce latency overhead. Operations C1-C4 are lightweight and thus do not violate the stringent latency constraints of the fronthaul. Specifically, for all the operations above, the processing overhead introduced in the fronthaul ranges from approximately 80 ns up to 20 μs, including the compression/decompression step. Such a delay is invisible to the higher-layer protocols, allowing attacks without breaking the RU to DU connection.

In the simple forwarding state (before any packet manipulation), an adversary can perform passive eavesdropping on fronthaul traffic, obtaining cell information that could be used in other attacks. For example, by collecting sufficient downlink traffic samples in a DU-RU fronthaul connection, adversaries can capture periodically transmitted and unencrypted MIB (Master Information Block), SSB, and SIB1 messages within these samples. Using the same signal processing techniques as those employed by the base station, which are openly standardized and easily accessible through open-source implementations like OpenAirInterface and srsRAN, adversaries can infer important cell configurations such as the cell numerology, physical cell ID (PCI), Public Land Mobile Network (PLMN) ID, I/Q sample compression scheme, and symbol positions for PRACH data. Moreover, this information enables adversaries to launch more targeted attacks. Specifically, the above information allows a motivated adversary to create a complete map of all the cells hosted by the DU and then designate which cells to attack based on a range of cell IDs.

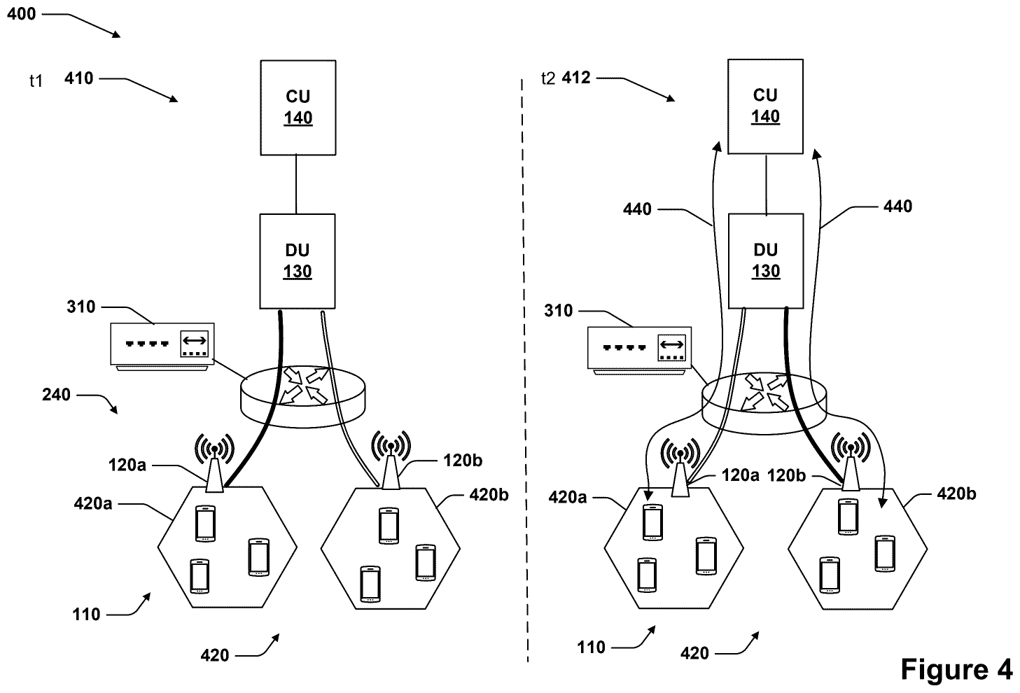

FIG. 4 is a diagram 400 of an example of a first signaling storm attack via cell re-selection. The high-level idea behind signal storm attacks is to force UEs 110 to generate a high rate of signaling messages toward the CU 140. Consequently, the CU 140 can become unresponsive, negatively impacting users in a wide region beyond the cells that are directly under attack

The first attack utilizes a 5G radio event called Radio Link Failure (RLF) which occurs when the radio link between the UE 110 and the DU 130 is lost, e.g., due to interference, bad coverage, and failed handovers. When this happens, the UE 110 will seek to recover the signal and set an RLF timer for this process. If the recovery fails and the timer expires (typically in a few hundred milliseconds), the UE 110 will trigger a process called cell re-selection. In this re-selection process, the UE measures the signal strength of available cells 420 within its range and selects the one with the best signal for attachment. Then, the UE establishes a connection with the chosen cell, triggering message exchanges between the DU 130 and the CU 140. A natural cell-reselection spans 12 messages (7 DU-to-CU and 5 CU-to-DU). At a high level, the UE triggers the process by sending an RRC Reestablishment Request message to the CU via the DU, followed by a sequence of messages by which the CU tears down the context of the UE from the old cell and creates a new context at the new cell.

This attack leverages the fact that the cell re-selection process generates a long sequence of messages to/from the CU 140, and a single cell can have hundreds of UEs attached or in an active state. Therefore, the attack forces all the UEs 110 to perform a cell re-selection to cause a signaling storm. This attack uses capability C1, which periodically steers the fronthaul packets of cells from one RU 120 to another by swapping the MAC addresses. This action makes the RUs 120 transmit the signal of a different cell every few seconds, making the UEs 110 experience an RLF and periodically trigger the cell re-selection process.

This attack is illustrated in FIG. 4, for the case of two cells 420a and 420b. During time window t1 410, the rogue server 310 forwards the traffic between the RUs 120a and 120b and the DU 130, with RU 120a communicating with cell 420a and RU 120b with cell 420b. However, in time window t2 412, the rogue server 310 swaps the MAC addresses of fronthaul packets, steering all the traffic of cell 420a to/from RU 120b and all traffic of cell 420b to/from RU 120a. As a result, the UEs 110 lose the signal of their original cell and are forced to trigger the cell re-selection process and attach to the new cell that is visible to them. In time window t3, the rogue server 310 returns to the same MAC address assignment as in t1 410, making the RUs transmit their original signal and triggering another cell re-selection. This process is repeated periodically, every few seconds, generating a constant volume of control plane traffic 440 to/from the CU proportional to the number of active UEs in the affected cells.

The impact of this attack on the CU 140 can be measured by counting the number of messages ex-changed between the DU and the CU for a varying number of UEs for one minute. The number of signaling messages increases linearly with the number of UEs. In validation experiments, more than 1400 signaling messages were generated with just four UEs in just one minute. To put these numbers into perspective, just 500 IoT devices generating more than 100 signaling events per hour could lead to network congestion Considering that, according to recent measurement studies, real cells typically have more than 40 UEs active at any point in time, this attack could generate up to 30K signaling messages per minute (1.8 M per hour) for just the two cells of the validation experiment.

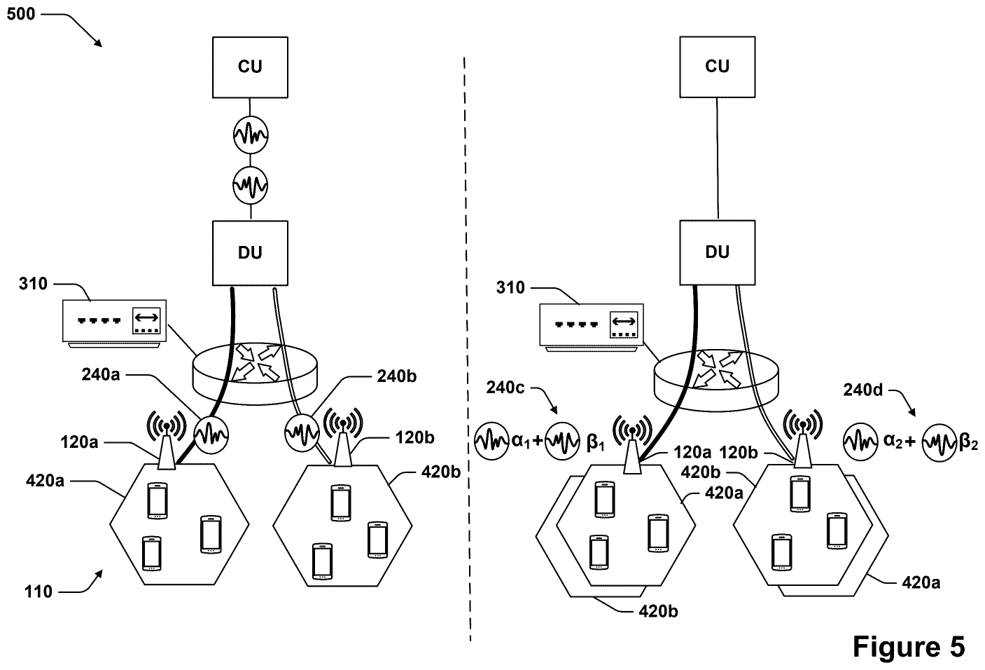

FIG. 5 is a diagram 500 of a second example signaling storm attack via handovers. The above re-selection based attack is limited in the number of times the cell re-selection can be triggered (i.e., approximately once every two seconds). The second example signaling storm attack can place even more stress on the CU 140 by leveraging a different 5G process, namely intra-DU handovers (i.e., UE handovers between cells of the same DU). This enables generation of nearly twice the number of signaling messages compared to the re-selection based attack, all within the same time frame.

The idea behind this attack is to give UEs an illusion that the signal quality of their attached cell goes below some threshold compared to a neighboring cell. This event triggers the intra-DU handover process. Once the UE 110 detects that the signal quality of the current cell is below some threshold compared to a neighboring cell, it sends a measurement report to the CU 140. The CU 140 then triggers a handover (six messages), which involves the CU 140 notifying the DU 130 about the cell change and re-configuring the context of the UE 110.

While the handover process requires fewer CU-DU signaling messages than the cell re-selection process (seven messages for handover vs. twelve messages for cell re-selection), the handover can be performed more frequently, leading to a larger total number of CU signaling messages. The handover frequency is (among others) driven by two CU-configured parameters called Hysteresis and TimeToTrigger. Hysteresis indicates a condition that must be met for the UE 110 to move to a new cell (e.g., new cell has N dB higher signal quality), while TimeToTrigger indicates how long this condition has to be met for the handover to be triggered (e.g., M ms), to avoid ping-pong effects. The TimeToTrigger value is typically configured as a few tens or hundreds of milliseconds. Thus, a handover could be triggered several times per second, assuming the Hysteresis condition is met.

To launch this attack, the rogue server 310 can multiplex the I/Q samples 240 of fronthaul traffic between multiple cells, by leveraging capabilities C2-C4. Specifically, as illustrated in FIG. 5, the rogue server 310 can combine the payload of U-plane packets targeting the same slot and antenna port of two cells by scaling their I/Q samples 240a and 240b by some factor (capability C3), summing up the results (capability C2), and then using the result (I/Q samples 240c and 240d) as the new payload of the packet (capability C4). Capability C2 allows the rogue server 310 to overlap the coverage area of two cells on the same RU 120, allowing all UEs in the range of the RU 120 under attack to detect both cells 420a and 420b. By frequently re-adjusting the signal quality of each cell through the scaling factor of capability C3, the rogue server 310 can manipulate the signal quality of the cells and, consequently, the observed Hysteresis, making one cell appear to have a stronger signal quality than the other and triggering a handover. A few hundred milliseconds later, the rogue server 310 can re-adjust the scaling factors (a and B) of the two cells, forcing all the UEs 110 to move back to the original cell through another round of handovers.

As with the reselection based attack, the feasibility of this attack based on number of signaling messages was tested using two cells. The Hysteresis parameter was set to 0.5 dB and the TimeToTrigger to 40 ms. The test used a scaling factor of 1 for cell 420a (no signal attenuation) and 0.8 for cell 420b, swapping the scaling factors of the two cells every 700 ms. Observations showed that a handover was triggered approximately every 700 ms due to a UE measurement report, once the scaling factors of the cells under attack were swapped. The number of signaling messages increased linearly with the number of UEs, but in this case, more than 2500 signaling messages were generated for four UEs (approximately three handovers every two seconds), a number almost double that of the re-selection based attack.

The physical layer attacks leverage capabilities C3 and C4 to modify radio signals (at the packet level) and break the connection and/or performance of UEs in the cell region. Three attacks targeting distinct aspects of the fronthaul traffic, e.g., user packet payload, downlink SSB symbols, and uplink PRACH symbols. While achieving similar effects as physical layer attacks in the literature (e.g., fake base station attacks and signal overshadowing), these attacks possess the capability to extend their impact to all cells controlled by the victim DU.

The most straightforward physical layer attack is to corrupt regular packets by replacing I/Q samples with invalid user payloads using capability C4 (e.g., with random or all-zero payloads). The rationale behind this attack is that the modified I/Q samples could result in decoding failures and packet drops during the signal processing at the physical layer. From the perspective of UEs, the effects of the modified packets manifest as packet loss at the RAN L2 layer or as noise into their communication channels, which forces the base station to perform retransmissions and to use more robust and less efficient modulation and coding schemes. Both effects eventually lead to the reduction of the traffic rate for the UE.

The payload corruption attack was tested in both directions by injecting invalid packets to disrupt randomly selected symbols carrying user data and/or signal quality reference signals. In the test, the rogue server 310 corrupted packets at a rate of 75 packets/sec. The attack significantly reduced connection throughput by 57% on average for downlink and by 71% on average for uplink. The percentage of throughput effectiveness increased with the corruption rate, leading to a throughput drop of up to 76% for downlink and 85% for uplink with a corruption rate of 150 packets/sec. The measured Channel Quality Information (CQI) of the UE under study during the attack dropped from 15 to 13.5 on average. This means the quality of the channel, as perceived by the UE, degraded, forcing the radio resource scheduler to choose more robust, but less efficient, modulation and coding schemes. Meanwhile, the block error rate (BLER) increased from almost 0% to more than 10% when the attack started, meaning a higher fraction of erroneous blocks were received and had to be retransmitted.

A second physical layer attack relies on periodically broadcasted control signals for initial access, collectively called the Synchronization Signal Block (SSB). This block includes four parts: Primary Synchronization Signal (PSS), Secondary Synchronization Signal (SSS), Physical Broadcast Channel (PBCH), and PBCH DeModulation Reference Signal (PBCH-DMRS). When 5G UEs try to attach to a cell, they rely upon the PSS and SSS signals to attain both time and frequency synchronization and obtain the cell PCI. After that, UEs decode the Master Information Block (MIB) from PBCH, a succinct 23-bit structure containing eight parameters crucial for cell selection. Notably, the pdcch-ConfigSIB1 parameter dictates which time and frequency resources UEs need to decode SIB1, encompassing additional essential information along with the MIB. The cellBarred field determines whether UEs are permitted to select this particular cell, while the intraFreqReselection bit signifies if intra-frequency cell selection is allowed in the presence of cell barring. Any failure in the receipt or decoding of SSB elements will render UEs unable to attach to the cell. As mentioned above, SSB belongs to the broadcast messages that lack protection from PDCP, so the rogue server 310 can tamper with these signals to disrupt the initial access procedures. Various attacks are conceivable. A naïve approach is to modify the I/Q samples containing the SSBs with meaningless content to obscure the normal ones, similar to the payload corruption attack. This disrupts the ability of UEs to decode the block, leading to failures in synchronization and subsequent steps. A more advanced adversary could achieve similar effects by selectively altering specific bits within the SSB. For instance, adversaries can introduce SSBs with incorrect PCIs or erroneous SIB1 configurations. It is particularly potent to manipulate the cellBarred parameter, as it enforces a 300-second restriction period before UEs can re-check the MIB. These attacks render new UEs unable to establish attachments with the cell, and they cause already connected UEs to detach from the cell.

A test implemented one type of SSB modification in which the adversary replaces the I/Q samples carrying SSB packets with an incorrect PCI. This manipulation disrupts the attachment of new UEs to the cell and causes existing UEs to detach from the cell due to the PCI mismatch. The spoofed SSB injection led to decoding of the wrong PCI. Consequently, neither the phone nor simulated UEs could attach.

A third physical layer attack targets the uplink PRACH, which also plays a vital role in the 5G initial access procedure. PRACH enables UEs to establish synchronization with the network, initiate connection requests, and efficiently identify themselves to the base station. The precise periodicity and location of PRACH data transmissions can be determined from the information captured in the SIB1 data block. UEs can begin uplink synchronization with the cell by transmitting PRACH preambles at pre-specified times, allowing the cell to detect their presence, estimate timing and frequency synchronization, and assign initial identifiers. Upon successful preamble reception, the cell responds with uplink grants, specifying resources for further communication. This procedure ensures seamless and efficient access to the 5G network, facilitating the establishment of robust connections for data transfer and communication. As a result, by manipulating uplink PRACH packets, adversaries can prevent new UEs from attaching to the cell while permitting already connected UEs to continue using the cell without interruption.

The PRACH attack was tested using a phone UE and a simulated UE. Prior to the attack, the simulated UE was attached to the cell and initiated a TCP/UDP connection. Subsequently, the attack started by corrupting PRACH packets using capability C4. Then the phone UE attempted to attach to the cell. The simulated UE remained unaffected during the attack, while the phone UE failed to attach to the cell. Although the phone UE sent out the attachment request, the phone UE failed to get a response because the rogue server 310 corrupted its PRACH symbols.

According to the 5G O-RAN deployment principles, an O-RAN edge data center typically deploys a cluster of DU servers to serve a group of neighboring cells, improving energy- and cost-efficiency. As a result, physical layer attacks have the advantage of amplifying the attack impact by attacking multiple cells served by the same DU together or employing multiple rogue machines to attack multiple DUs and their associated cells. This could allow the rogue server 310 to disrupt cellular network services for a large geographical region, such as an entire campus or small town. Moreover, the rogue server 310 could also attack multiple cells by employing different attack vectors, e.g., targeting some cells using SSB injection while using PRACH injection for others. This would expand the impact area and increase the complexity of diagnosing and mitigating the attacks.

FIG. 6 is a schematic diagram of an example of an apparatus 600 (e.g., a computing device) for identifying potentially compromised fronthaul interfaces of a communication network (e.g., a 5G network). The apparatus 600 may be implemented as one or more computing devices in the vRAN 100.

In an example, the apparatus 600 includes at least one processor 602 and a memory 604 configured to execute or store instructions or other parameters related to providing an operating system 606, which can execute one or more applications or processes, such as, but not limited to, the fronthaul security application 190. For example, processors 602 and memory 604 may be separate components communicatively coupled by a bus (e.g., on a motherboard or other portion of a computing device, on an integrated circuit, such as a system on a chip (SoC), etc.), components integrated within one another (e.g., a processor 602 can include the memory 604 as an on-board component), and/or the like. Memory 604 may store instructions, parameters, data structures, etc. for use/execution by processor 602 to perform functions described herein. In some implementations, the memory 604 includes the database 652 for use by the fronthaul security application 190.

In an example, the fronthaul security application 190 includes the monitoring component 192, anomaly component 194, identification component 196, and mitigation component 198 discussed above with respect to FIG. 1.

In an aspect, the fronthaul security application 190 is configured to detect and mitigate the attacks on the fronthaul network described herein. These attacks have several characteristics that increase the difficulty of detection. For example, many of the capabilities and manipulations of the rogue server 310 are performed on downlink traffic that is only handled by the RU 120 and the UEs 110 after manipulation. Accordingly, more central network nodes (e.g., real-time RIC 162 or near-real-time RIC 172) with intelligence for analysis may not be able to directly inspect the packets. Instead, the central network nodes may rely on reporting messages from UEs 110. Additionally, because the manipulated packets include I/Q samples corresponding to radio transmissions, some distortion due to noise and interference is expected, so distinguishing an attack from natural noise and interference may be difficult.

The monitoring component 192 is configured to monitor characteristics of a plurality of packets transmitted over an interface between a radio unit and a distributed unit. In particular, the characteristics may be specific to the attacks described herein. For example, one characteristic is microsecond level timing information of the plurality of packets transmitted over the fronthaul interface 122. Microsecond level timing information may be based on a timestamp of each fronthaul packet, from which several statistical properties (mean/tail inter-packet delay, pattern periodicity, etc.) can be inferred. Alternatively, a network function may report such statistical properties via codelet 132. In an example, although the latency tolerance of the fronthaul may be approximately 100 μs, in order to meet this tolerance, the Ethernet links 126 transmit packets 222 according to regular patterns, which may be tied to configured parameters of the radio interface such as symbol duration, cell bandwidth, and TDD pattern. For instance, there may be a longer delay for downlink packets corresponding to symbols that are designated for only uplink. The pattern for a particular deployment can be learned through simple statistical analysis. The typical deviation of the time between packets 222 from the learned pattern is on the order of several microseconds. Although the manipulations of the rogue server 310 are fast enough to satisfy the latency tolerance of the fronthaul, an increase in a previously observed variance of the time between packets or greater deviation from a learned pattern may be indicative of operation of a rogue server 310. As another example, the signal storm based attacks rely on increasing a rate of messages such as radio link failure or measurement reports. A sudden increase in these types of messages from cells provided by a single DU may be indicative of an attack. Similarly, the payload corruption attack may result in reporting of a lower CQI by the UE 110 or a BLER detected at the DU 130. Changes to these metrics may indicate an attack, especially if correlated with physical layer measurements (e.g., RSRP) that indicate good channel conditions.

The anomaly component 194 is configured to detect an anomaly based on a deviation in the characteristics among the plurality of packets transmitted over the interface. For example, the anomaly component 194 may establish baseline metrics for any of the characteristics monitored by the monitoring component 192. The baseline metrics may establish acceptable ranges or threshold values for the characteristics. The anomaly component 194 may detect an anomaly when a value of the monitored characteristic is outside of the acceptable range or satisfies a threshold value. In some implementations, the anomaly component 194 is configured to correlate a first characteristic based on a physical layer measurement of the plurality of packets transmitted over the interface with second characteristic based on quantity of radio link control layer messages or radio resource control layer messages. In some implementations, the first characteristic may be reported from a network function (e.g., DU 130) via a codelet 132. The second characteristic may be a higher layer key performance indicator (KPI) reported from the network function according to a service model or via a codelet 132. For instance, the anomaly component 194 may determine whether an increase in microsecond level timing of packets transmitted on the link 126 is associated with an increase in radio link failure messages or measurement reports requesting a handover. As another example, a correlation between an increase in physical layer RSRP, CQI, or BLER and a deviation in microsecond level timing may indicate anomalous behavior such as a payload corruption attack. Such a correlation may also detect a hardware issue such as a faulty network interface controller, but an alert and inspection may be warranted in either case. In some implementations, lack of correlation between L1-RSRP and CQI reported by a UE may indicate that a payload corruption attack has occurred.

The identification component 196 is configured to identify the interface between the radio unit and the distributed unit as potentially compromised based at least in part on the anomaly. In some implementations, the identification component 196 may generate an alert that indicates the interface is potentially compromised. The alert may direct a maintenance team to inspect the physical hardware of the connection for presence of a rogue server 310. Similarly, the alert may trigger debugging or version control assessment of software for the DU 130 and/or RU 120 and any intermediary switches 124.

The mitigation component 198 may be configured to control one or both of the radio unit or the distributed unit to perform a mitigation action in response to identifying the interface as potentially compromised. For example, because signaling storm attacks have the potential to impact the CU 140, a mitigation action may include shutting down one or more cells associated with the DU 130 and offloading UEs to neighbor cells. In some implementations, a DU 130 may be reduced to a single cell to limit signaling storm attacks that generate intra-DU reselection or handover. As another example, the mitigation action may include temporarily limiting a number of UEs permitted to perform a handover. For instance, the CU 140 may only grant a limited number of handovers in a time period, which may reduce the number of RRC messages exchanged.

In an aspect, a mitigation action may include performing integrity protection on packets transmitted over an Ethernet connection between a DU 130 and a RU 120. For example, Media Access Control Security (MACsec) is a widely adopted security protocol that provides frame data integrity and data origin authenticity at the data link layer. MACSec computes an Integrity Check Value (ICV) and attaches it to each packet, enabling devices to identify and discard injected packets with incorrect ICVs. As noted above, the standards organizations have not adopted integrity protection due to potential effects on latency. These effects may be reduced. For example, integrity protection using hardware accelerated encryption (e.g., Advanced Encryption Standard Instructions (AES-NI)) to encode an Ethernet frame can reduce integrity protection from approximately 80 μs to 2.4 μs, which would be acceptable for latency requirements.

Another approach that does not require hardware acceleration is to add integrity protection to selected parts of the fronthaul packets, which would be enough to mitigate the most critical attacks discussed above, but with much lower overhead. Lower overhead would be important for larger scale scenarios (e.g., Massive MIMO cells with 32 or 64 antennas). For example, by adding integrity protection to the parts of the packets that are not integrity protected by the higher layers (e.g., eCPRI headers, the MIB/SIB and the radio resources carrying signal quality measurements), the signal storm based attacks can be mitigated by integrity-protecting a few tens of bytes per fronthaul packet. The bits on which to perform integrity protection may be statically configured along with the radio grid resources (e.g., location and periodicity of SSB, TDD configuration, etc.) This selective integrity protection can reduce the latency overhead per integrity-protection operation to less than 0.3 μs on average, which makes integrity protection practical for all scenarios of interest. In some implementations, integrity protection using either hardware acceleration or protection of parts of the packets may be implemented proactively (e.g., before an actual attack is detected).

In some implementations, the apparatus 600 is implemented as a distributed processing system, for example, with multiple processors 602 and memories 604 distributed across physical systems such as servers, virtual machines, or datacenters 160, 170. For example, one or more of the components of the fronthaul security application 190 may be implemented as services executing at different datacenters 160, 170. The services may communicate via an API.

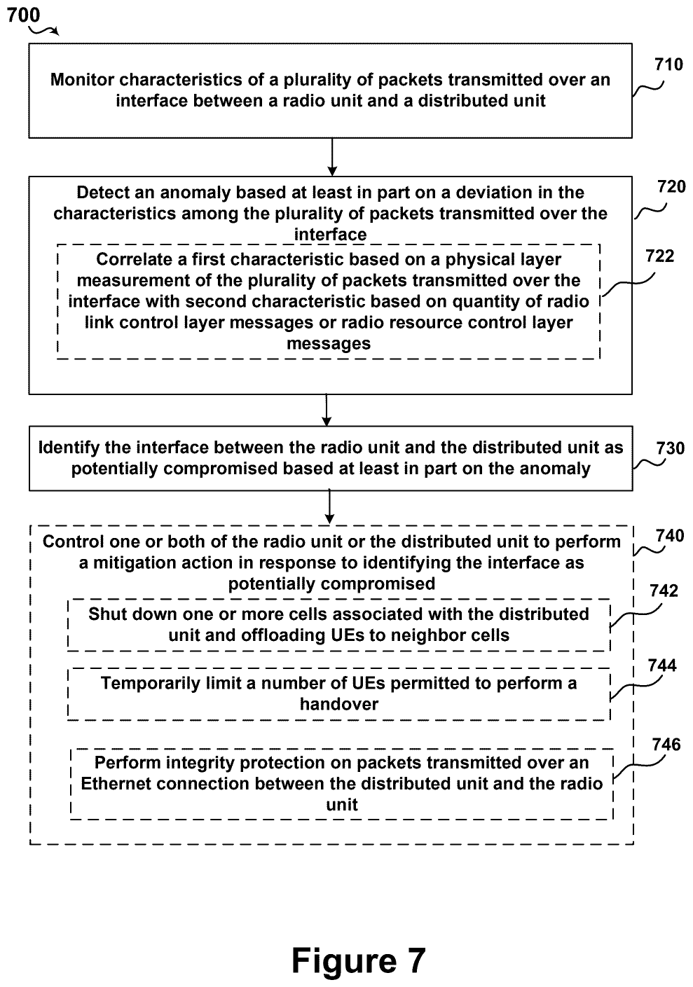

FIG. 7 is a flow diagram of an example of a method 700 for providing security in a fronthaul of a communication network (e.g., a 5G network). For example, the method 700 can be performed by the fronthaul security application 190, the apparatus 600 and/or one or more components thereof to identify potentially compromised fronthaul links.

At block 710, the method 700 includes monitoring characteristics of a plurality of packets transmitted over an interface between a radio unit and a distributed unit. For example, in an aspect, apparatus 600, processor 602, memory 604, and/or fronthaul security application 190 and/or monitoring component 192 may be configured to or may comprise means for monitoring characteristics of a plurality of packets 222 transmitted over the fronthaul interface 122 between a RU 120 and a DU 130. In some implementations, the characteristic is microsecond level timing information of the plurality of packets transmitted over the interface. In some implementations, the characteristic is a rate of radio link failures reported over the interface between the radio unit and the distributed unit. In some implementations, the characteristic is a channel quality indicator reported by user equipment connected to the radio unit. In some implementations, the characteristic is a quantity of measurement reports indicating handover conditions within a window of time. For instance, the rate of radio link failures, the channel quality indicator, and/or the quantity of measurement reports can be calculated at the RRC layer for each interface.

At block 720, the method 700 includes detecting an anomaly based on a deviation in the characteristics among the plurality of packets transmitted over the interface. For example, in an aspect, apparatus 600, processor 602, memory 604, fronthaul security application 190, and/or anomaly component 194 may be configured to or may comprise means for detecting an anomaly based on a deviation in the characteristics among the plurality of packets 222 transmitted over the fronthaul interface 122. For example, when the characteristics include microsecond level timing information, the deviation may be a variation in the microsecond level timing information that is greater than a threshold. When the characteristics include a rate of radio link failures, a channel quality indicator, or a quantity of measurement reports, the deviation may be a value that is outside of a range or a change that exceeds a threshold. In some implementations, at sub-block 722, the block 720 may optionally include correlating a first characteristic based on a physical layer measurement of the plurality of packets transmitted over the interface with second characteristic based on quantity of radio link control layer messages or radio resource control layer messages.

At block 730, the method 700 includes identifying the interface between the radio unit and the distributed unit as potentially compromised based at least in part on the anomaly. For example, in an aspect, apparatus 600, processor 602, memory 604, fronthaul security application 190, and/or identification component 196 may be configured to or may comprise means for identifying the fronthaul interface 122 between the RU 120 and the DU 130 as potentially compromised based at least in part on the anomaly.

At block 740, the method 700 includes controlling one or both of the radio unit or the distributed unit to perform a mitigation action in response to identifying the interface as potentially compromised. For example, in an aspect, apparatus 600, processor 602, memory 604, fronthaul security application 190, and/or mitigation component 198 may be configured to or may comprise means for controlling one or both of the radio unit or the distributed unit to perform a mitigation action in response to identifying the interface as potentially compromised. For example, in some implementations, at sub-block 742, the block 740 may optionally include, shutting down one or more cells associated with the distributed unit and offloading UEs to neighbor cells. As another example, in some implementations, at sub-block 744, the block 740 may optionally include temporarily limiting a number of UEs permitted to perform a handover.

In some implementations, at sub-block 746, the block 740 may optionally include performing integrity protection on packets transmitted over an Ethernet connection between the distributed unit and the radio unit. In some implementations, the sub-block 746 may be performed pre-emptively to prevent an attack on a compromised link. In other implementations, the integrity protection may be activated in response to identifying a potentially compromised link. For example, adding integrity protection may incur costs in terms of processing cycles and latency that can be avoided if the link is not suspected of being compromised. In some implementations, the integrity protection includes encoding an Ethernet frame including a fronthaul traffic packet using hardware accelerated encryption. The hardware accelerated encryption reduces latency of the integrity protection to acceptable levels. In some implementations, the integrity protection includes encoding one or more parts of an Ethernet frame including a fronthaul traffic packet that are not protected by a higher layer protocol. For example, the one or more parts may include an eCPRI header, a MIB/SIB, or a signal quality measurement. Integrity protection on these parts may prevent the attacks described herein while incurring acceptable levels of latency for the integrity protection.

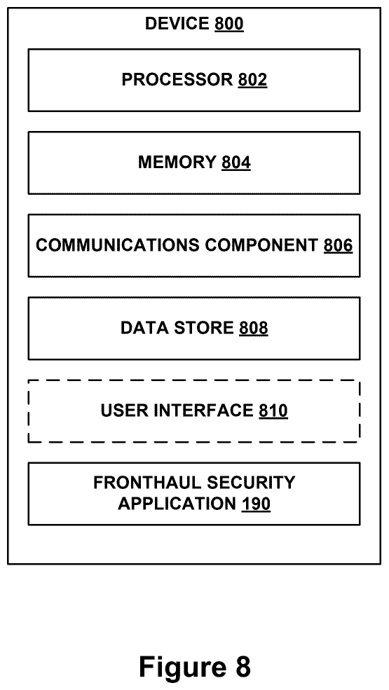

FIG. 8 illustrates an example of a device 800 including additional optional component details as those shown in FIG. 6. In one aspect, device 800 includes processor 802, which may be similar to processor 602 for carrying out processing functions associated with one or more of components and functions described herein. Processor 802 can include a single or multiple set of processors or multi-core processors. Moreover, processor 802 can be implemented as an integrated processing system and/or a distributed processing system.

Device 800 further includes memory 804, which may be similar to memory 604 such as for storing local versions of operating systems (or components thereof) and/or applications being executed by processor 802, such as the fronthaul security application 190, the monitoring component 192, the anomaly component 194, the identification component 196, the mitigation component 198, etc. Memory 804 can include a type of memory usable by a computer, such as random access memory (RAM), read only memory (ROM), tapes, magnetic discs, optical discs, volatile memory, non-volatile memory, and any combination thereof. The processor 802 may execute instructions stored on the memory 804 to cause the device 800 to perform the methods discussed above with respect to FIG. 7.

Further, device 800 includes a communications component 806 that provides for establishing and maintaining communications with one or more other devices, parties, entities, etc. utilizing hardware, software, and services as described herein. Communications component 806 carries communications between components on device 800, as well as between device 800 and external devices, such as devices located across a communications network and/or devices serially or locally connected to device 800. For example, communications component 806 may include one or more buses, and may further include transmit chain components and receive chain components associated with a wireless or wired transmitter and receiver, respectively, operable for interfacing with external devices.

Additionally, device 800 may include a data store 808, which can be any suitable combination of hardware and/or software, that provides for mass storage of information, databases, and programs employed in connection with aspects described herein. For example, data store 808 may be or may include a data repository for operating systems (or components thereof), applications, related parameters, etc. not currently being executed by processor 802. In addition, data store 808 may be a data repository for the fronthaul security application 190.

Device 800 may optionally include a user interface component 810 operable to receive inputs from a user of device 800 and further operable to generate outputs for presentation to the user. User interface component 810 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 810 may include one or more output devices, including but not limited to a display, a speaker, a haptic feedback mechanism, a printer, any other mechanism capable of presenting an output to a user, or any combination thereof.

Device 800 additionally includes the fronthaul security application 190 identifying potentially compromised fronthaul interfaces and mitigating potential attacks to the vRAN 100 via those interfaces.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer-readable media excludes transitory signals.

The following numbered clauses provide an overview of aspects of the present disclosure:

Clause 1. An apparatus comprising: one or more memories storing computer executable instructions; and one or more processors coupled with the one or more memories and, individually or in combination, configured to: monitor characteristics of a plurality of packets transmitted over an interface between a radio unit and a distributed unit; detect an anomaly based at least in part on a deviation in the characteristics among the plurality of packets transmitted over the interface; and identify the interface between the radio unit and the distributed unit as potentially compromised based at least in part on the anomaly.

Clause 2. The apparatus of clause 1, wherein the characteristics include microsecond level timing information of the plurality of packets transmitted over the interface and the deviation is a variation in the microsecond level timing information that is greater than a threshold.

Clause 3. The apparatus of clause 1 or 2, wherein the characteristics include a rate of radio link failures reported over the interface between the radio unit and the distributed unit.

Clause 4. The apparatus of any of clauses 1-3, wherein the characteristics include a channel quality indicator reported by user equipment connected to the radio unit.

Clause 5. The apparatus of any of clauses 1-4, wherein the characteristics include a quantity of measurement reports indicating handover conditions within a window of time.

Clause 6. The apparatus of any of clauses 1-5, wherein to detect the anomaly, the one or more processors, individually or in combination, are configured to correlate a first characteristic based on a physical layer measurement of the plurality of packets transmitted over the interface with second characteristic based on quantity of radio link control layer messages or radio resource control layer messages.

Clause 7. The apparatus of any of clauses 1-6, wherein the one or more processors, individually or in combination, are configured to control one or both of the radio unit or the distributed unit to perform a mitigation action in response to identifying the interface as potentially compromised.

Clause 8. The apparatus of clause 7, wherein the mitigation action includes shutting down one or more cells associated with the distributed unit and offloading UEs to neighbor cells.

Clause 9. The apparatus of clause 7 or 8, wherein the mitigation action includes temporarily limiting a number of UEs permitted to perform a handover.

Clause 10. The apparatus of any of clauses 7-9, wherein the mitigation action includes performing integrity protection on packets transmitted over an Ethernet connection between a distributed unit and a radio unit.

Clause 11. The apparatus of clause 10, wherein the integrity protection includes encoding an Ethernet frame including a fronthaul traffic packet using hardware accelerated encryption.

Clause 12. The apparatus of clause 10, wherein the integrity protection includes encoding one or more parts of an Ethernet frame including a fronthaul traffic packet that are not protected by a higher layer protocol.

Clause 13. The apparatus of clause 12, wherein the one or more parts include an eCPRI header, a MIB/SIB, or a signal quality measurement.

Clause 14. A method of security in a 5G fronthaul network, comprising: monitoring characteristics of a plurality of packets transmitted over an interface between a radio unit and a distributed unit; detecting an anomaly based at least in part on a deviation in the characteristics among the plurality of packets transmitted over the interface; and identifying the interface between the radio unit and the distributed unit as potentially compromised based at least in part on the anomaly.

Clause 15. The method of clause 14, wherein the characteristics include microsecond level timing information of the plurality of packets transmitted over the interface and the deviation is a variation in the microsecond level timing information that is greater than a threshold.

Clause 16. The method of clause 14 or 15, wherein the characteristics include one or more of: a rate of radio link failures reported over the interface between the radio unit and the distributed unit; a channel quality indicator reported by user equipment connected to the radio unit; or a quantity of measurement reports indicating handover conditions within a window of time.

Clause 17. The method of any of clauses 14-16, detecting the anomaly comprises correlating a first characteristic based on a physical layer measurement of the plurality of packets transmitted over the interface with second characteristic based on quantity of radio link control layer messages or radio resource control layer messages.

Clause 18. The method of any of clauses 14-17, further comprising controlling one or both of the radio unit or the distributed unit to perform a mitigation action in response to identifying the interface as potentially compromised.

Clause 19. The method of clause 18, wherein the mitigation action includes one or more of: shutting down one or more cells associated with the distributed unit and offloading UEs to neighbor cells; temporarily limiting a number of UEs permitted to perform a handover; or integrity protection on packets transmitted over an Ethernet connection between a distributed unit and a radio unit.

Clause 20. A non-transitory computer-readable medium storing computer-executable instructions that when executed by one or more processors of a network node, cause the network node to: monitor characteristics of a plurality of packets transmitted over an interface between a radio unit and a distributed unit; detect an anomaly based at least in part on a deviation in the characteristics among the plurality of packets transmitted over the interface; and identify the interface between the radio unit and the distributed unit as potentially compromised based at least in part on the anomaly.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus comprising:
one or more memories storing computer executable instructions; and
one or more processors coupled with the one or more memories and, individually or in combination, configured to:
monitor characteristics of a plurality of packets transmitted over an interface between a radio unit and a distributed unit including a microsecond level timing information of the plurality of packets transmitted over the interface;
detect an anomaly based at least in part on a deviation in the microsecond level timing information among the plurality of packets transmitted over the interface; and
identify the interface between the radio unit and the distributed unit as potentially compromised based at least in part on the anomaly.

2. The apparatus of claim 1, wherein to detect the anomaly, the one or more processors, individually or in combination, are configured to correlate a first characteristic based on a physical layer measurement of the plurality of packets transmitted over the interface with second characteristic based on quantity of radio link control layer messages or radio resource control layer messages.

3. The apparatus of claim 2, wherein the first characteristic is the microsecond level timing information of the plurality of packets transmitted over the interface and the deviation is a variation in the microsecond level timing information that is greater than a threshold.

4. The apparatus of claim 1, wherein the characteristics include a rate of radio link failures reported over the interface between the radio unit and the distributed unit.

5. The apparatus of claim 1, wherein the characteristics include a channel quality indicator reported by user equipment connected to the radio unit.

6. The apparatus of claim 1, wherein the characteristics include a quantity of measurement reports indicating handover conditions within a window of time.

7. The apparatus of claim 1, wherein the one or more processors, individually or in combination, are configured to control one or both of the radio unit or the distributed unit to perform a mitigation action in response to identifying the interface as potentially compromised.

8. The apparatus of claim 7, wherein the mitigation action includes shutting down one or more cells associated with the distributed unit and offloading UEs to neighbor cells.

9. The apparatus of claim 7, wherein the mitigation action includes temporarily limiting a number of UEs permitted to perform a handover.

10. The apparatus of claim 7, wherein the mitigation action includes performing integrity protection on packets transmitted over an Ethernet connection between a distributed unit and a radio unit.

11. The apparatus of claim 10, wherein the integrity protection includes encoding an Ethernet frame including a fronthaul traffic packet using hardware accelerated encryption.

12. The apparatus of claim 10, wherein the integrity protection includes encoding one or more parts of an Ethernet frame including a fronthaul traffic packet that are not protected by a higher layer protocol.

13. The apparatus of claim 12, wherein the one or more parts include an eCPRI header, a MIB/SIB, or a signal quality measurement.

14. A method of security in a 5G fronthaul network, comprising:
monitoring characteristics of a plurality of packets transmitted over an interface between a radio unit and a distributed unit including microsecond level timing information of the plurality of packets transmitted over the interface;
detecting an anomaly based at least in part on a deviation in the microsecond level timing information among the plurality of packets transmitted over the interface; and
identifying the interface between the radio unit and the distributed unit as potentially compromised based at least in part on the anomaly.

15. The method of claim 14, wherein the characteristics include microsecond level timing information of the plurality of packets transmitted over the interface and the deviation is a variation in the microsecond level timing information that is greater than a threshold.

16. The method of claim 14, detecting the anomaly comprises correlating a first characteristic based on a physical layer measurement of the plurality of packets transmitted over the interface with second characteristic based on quantity of radio link control layer messages or radio resource control layer messages.

17. The method of claim 14, wherein the characteristics include one or more of: a rate of radio link failures reported over the interface between the radio unit and the distributed unit; a channel quality indicator reported by user equipment connected to the radio unit; or a quantity of measurement reports indicating handover conditions within a window of time.

18. The method of claim 14, further comprising controlling one or both of the radio unit or the distributed unit to perform a mitigation action in response to identifying the interface as potentially compromised.

19. The method of claim 18, wherein the mitigation action includes one or more of:
shutting down one or more cells associated with the distributed unit and offloading UEs to neighbor cells;
temporarily limiting a number of UEs permitted to perform a handover; or
integrity protection on packets transmitted over an Ethernet connection between a distributed unit and a radio unit.

20. A non-transitory computer-readable medium storing computer-executable instructions that when executed by one or more processors of a network node, cause the network node to:
monitor characteristics of a plurality of packets transmitted over an interface between a radio unit and a distributed unit including microsecond level timing information of the plurality of packets transmitted over the interface;
detect an anomaly based at least in part on a deviation in the microsecond level timing information among the plurality of packets transmitted over the interface; and
identify the interface between the radio unit and the distributed unit as potentially compromised based at least in part on the anomaly.
